(19) United States
(12) Patent Application Publication
(10) Pub. No.: US 2021/0307564 A1
(43) Pub. Date: Oct. 7, 2021

(54) FROTHER FOR MILK BASED BEVERAGES

(71) Applicant: Alex Gort-Barten, Crawley (GB)

(72) Inventor: Alex Gort-Barten, Crawley (GB)

(21) Appl. No.: 17/268,231

(22) PCT Filed: Aug. 14, 2018
(86) PCT No.: PCT/EP2019/071820

§ 371 Date: Feb. 12, 2021

(30) Foreign Application Priority Data
Aug. 14, 2018 (GB) 1813265.4

(51) Int. Cl. A47J 43/07; A47J 43/046

(52) U.S. Cl. CPC A47J 43/0722; A47J 43/0465

(57) ABSTRACT

A frother comprising a chamber (1) for receiving milk or a liquid and a powder, drive means (2) adapted to drive a whisk (3), which whisk is adapted to rotate in the milk or milk based liquid to mix the milk or liquid with the powder, the frother further comprising heating means (4) adapted to heat the milk or liquid. A whisk is provided with cover means (11) arranged to prevent powder from settling into coils on the whisk.

Espresso based coffee drinks such as caffè latte and cappuccino have become increasingly popular and consumers want to be able to easily and reliably produce these drinks. Traditionally, baristas have been trained to use the steam generated by an espresso machine to heat and froth milk in a jug to produce the hot milk and froth required for these drinks. Producing the appropriate amount of hot milk and froth without burning the milk or damaging the jug requires some training or experience. Smaller espresso machines are also much harder to use to treat the milk.

A number of separate milk frothers have been produced which are suitable for home or small scale commercial use. EP1656866 discloses a frother with a tank to receive a milk-based liquid food with a magnetic beater. A magnetic beater driving system produces a magnetic field which drives the beater in rotation in the tank. The system, beater and a beater positioning unit break or prevent symmetrical circulation of the liquid around a median of vertical axis of the tank. Heating units are disposed in association with the tank for heating the liquid. This is used for preparing foam from a milk-based liquid food product.

GB2454421 discloses a device for frothing milk that is provided with a rotating heating element to be inserted in the milk. The device is provided with a whisk attachment for producing froth and a paddle attachment for producing a more creamy finish.

A further problem with the known frothers is that the milk tends to burn on the element as when the frother has frothed the milk, the user immediately pours the milk out and a small residue remains behind, which burns on the element. If this is not cleaned quickly, the burnt on residue becomes difficult to remove and also affects future performance. The standard approach to this has been to reduce the temperature to which the milk is heated to around 60 C but at this temperature, the frothed milk is not suitable for use in other beverages such as hot chocolate, which would require a higher temperature to be palatable.

GB2486872 represented a significant advance in the art of domestic milk frothers but is limited to use with milk.

The present invention therefore seeks to provide a frother that can be used for producing a wider range of in particular milk based beverages.

According to the invention there is provided a frother for milk based beverages comprising a tank for receiving milk or a milk based liquid, which tank has substantially vertical walls and a flat bottom, magnetic drive means adapted to drive removable whisk means, which whisk means is adapted to rotate in the milk or milk based liquid to mix the heating milk or milk based liquid, the frother further comprising heating means adapted to heat the milk or milk based liquid, the magnetic drive means being located outside of the tank, beneath the flat bottom of the tank, wherein the whisk means comprise a whisk comprising a plurality of coils, which whisk is mounted on a support arranged to hold the whisk off the flat bottom, the whisk means further comprising cover means which extend to substantially cover space above the whisk when the whisk is resting on the flat bottom.

Preferably, the whisk has a width or diameter in a plane co-planar with the flat bottom, the cover means having a width or diameter with substantially the same dimension or dimensions as the whisk.

Preferably, the cover means has a width or diameter greater than the width or diameter of the whisk.

Preferably, the support comprises an annular upstanding wall, which, in use, sits on the flat bottom of the tank, which wall is joined by radial arms to an axial spindle on which support a whisk is rotatably mounted, which rotatably mounted whisk is rotatable by the magnetic drive means, wherein the support holds the whisk off the flat bottom of the tank, the whisk being held in position by the whisk means rather than the magnetic drive means.

The provision of the cover means of the invention enables the frother to produce milk based beverages such as hot chocolate or follow on baby milk, which known frothers are unable to do safely, in which the frother also acts to blend the powder into the liquid without the powder settling into the coils of the whisk where it will jam the rotation leading to motor burn out. The cover also surprisingly interrupts the formation of a vortex immediately above the whisk improving the mixing or the powder and liquid.

An exemplary embodiment of the invention will now be described in greater detail with reference to the drawings in which:

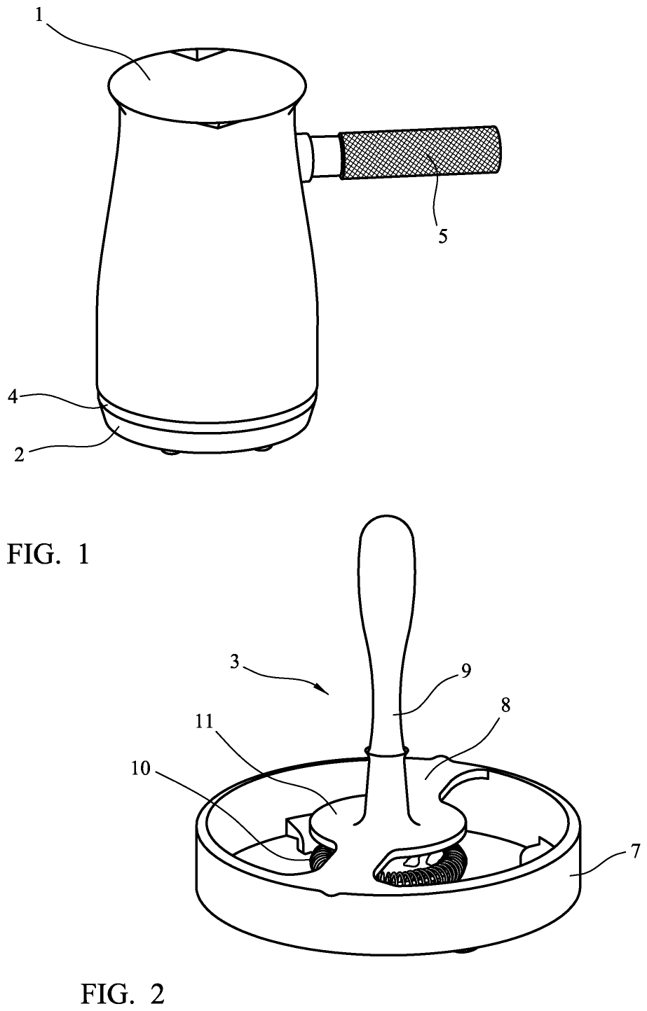

FIG. 1 shows a perspective view of the frother

FIG. 2 shows a perspective view of the whisk.

FIG. 1 shows a perspective view of a milk frother having a tank 1 having a generally circular outer and inner circumference for receiving milk to be frothed and a handle 5. A magnetic drive means 2 is provided below the lower surface of the tank 1, which drive means 2 is adapted to impart a drive to a stirrer or whisk means 3 located in the tank without a mechanical connection member intruding through the wall of the tank 1. The stirrer or whisk means 3 is supported on the base of the tank 1 to ensure that it remains centred and that the drive mechanism can impart drive to the stirrer.

A heating plate 4 is located beneath the base of the tank 1, which heating plate is adapted to heat the milk in use. The frother is provided with control means adapted to control the actuation of the heating plate and also, independently, the actuation of the magnetic drive means. The control means can be either a single ECU or independent PCB's. The magnetic drive means can also have more than one speed so that the liquid is not frothed, if for example follow on baby milk is being made.

In use, the control means are adapted to turn off the heating plate a predetermined time before the stirrer stops stirring so that the residual heat of the plate can be removed by the action of the stirrer passing the milk over it for the predetermined period of time. The length of time will depend on both the dimensions of the tank, the speed of the stirrer and the desired temperature of the milk. Typically, the predetermined length of time will need to be around 10s. This particular arrangement has the attraction of permitting the milk to be heated to a higher temperature than would otherwise be possible but by the time the milk is poured from the frother the base of the tank will have cooled sufficiently that any residual milk that is left in contact with the tank will not burn. For example, in a frother of the invention it is possible to heat the milk to 75 C, which is suitable for making hot chocolate, whereas in most prior art devices, the milk is only heated to around 60 C as any higher temperature would result in unacceptable levels of milk burning on the surface of the frother.

FIG. 2 shows a whisk in accordance with the invention. The whisk means 3 comprises an annular upstanding wall 7, which wall is joined by two radial arms 8 to an axial spindle 9. The spindle 9 extends above and below the radial arms 8. A whisk 10 is rotatably mounted on a rotatable drive shaft at the lower end of the spindle 9, which drive shaft is housed within the spindle 9. The radial arms 8 further comprise cover means 11, which extend above the whisk 10 such that it substantially covers the whisk when viewed from above in a vertical orientation. The cover means may be located around 5-10 mm above the whisk.

The cover means 11 prevent powder or flakes such as chocolate powder or baby milk powder or cocoa from settling on the coils of the whisk 10. The cover means 11 protect the spinning whisk in use from the chocolate flakes/powder as they are liable to melt thereby jamming the motor

In use, the whisk means holds the whisk 10 substantially concentrically with the magnetic drive means located in the main body. The whisk 10 is held above the surface of the flat bottom, typically by about 3 mm, thereby avoiding that the surface of the flat bottom might be scratched by the whisk action. This permits the interior of the tank 1 to be provided with either a polished stainless steel surface or alternatively a non stick coating. This also facilitates the magnetic drive means to run on for 20-30 seconds after the heating element is switched off. This enables the milk to be heated to a higher temperature suitable for hot chocolate drinks. The heat is dissipated throughout the milk and does not burn on the bottom surface of the container.

The radial arms 8 and cover means 11 will also interrupt the vortex that would develop due to the rotation of the whisk, which advantageously results in a better froth as well as increasing the working volume of the tank. The whisk means are also easily removable and are hence easy to clean. It would also be possible to ensure that the whisk means is dishwasher safe.

1. A frother for producing a beverage comprising a tank for receiving a liquid, which tank has substantially vertical walls and a flat bottom, magnetic drive means adapted to drive removable whisk means, which whisk means is adapted to rotate in the liquid to mix the heating liquid, the frother further comprising heating means adapted to heat the milk or milk based liquid, the magnetic drive means being located outside of the tank, beneath the flat bottom of the tank, wherein the whisk means comprise a whisk comprising a plurality of coils, which whisk is mounted on a support arranged to hold the whisk off the flat bottom, the whisk means further comprising cover means which extend to substantially cover space above the whisk when the whisk is resting on the flat bottom.

2. A frother according to claim 1, wherein the whisk has a width or diameter in a plane co-planar with the flat bottom, the cover means having a width or diameter with substantially the same dimension or dimensions as the whisk.

3. A frother according to claim 1, wherein the cover means has a width or diameter greater than the width or diameter of the whisk.

4. A frother according to claim 1, wherein the support comprises an annular upstanding wall, which, in use, sits on the flat bottom of the tank, which wall is joined by radial arms to an axial spindle on which support a whisk is rotatably mounted, which rotatably mounted whisk is rotatable by the magnetic drive means, wherein the support holds the whisk off the flat bottom of the tank, the whisk being held in position by the whisk means rather than the magnetic drive means.

5. A frother according to claim 2, wherein the cover means has a width or diameter greater than the width or diameter of the whisk.

6. A frother according to claim 2, wherein the support comprises an annular upstanding wall, which, in use, sits on the flat bottom of the tank, which wall is joined by radial arms to an axial spindle on which support a whisk is rotatably mounted, which rotatably mounted whisk is rotatable by the magnetic drive means, wherein the support holds the whisk off the flat bottom of the tank, the whisk being held in position by the whisk means rather than the magnetic drive means.

7. A frother according to claim 3, wherein the support comprises an annular upstanding wall, which, in use, sits on the flat bottom of the tank, which wall is joined by radial arms to an axial spindle on which support a whisk is rotatably mounted, which rotatably mounted whisk is rotatable by the magnetic drive means, wherein the support holds the whisk off the flat bottom of the tank, the whisk being held in position by the S than the magnetic drive means.
